(19) United States
(12) Patent Application Publication
(10) Pub. No.: US 2012/0107554 A1
(43) Pub. Date: May 3, 2012

(54) TCO Coating and Coated Substrate for High Temperature Applications

(76) Inventors: Gary L. Pfaff, Cazenovia, WI (US); James E. Brownlee, Richland Center, WI (US); Annette J. Krisko, Sauk City, WI (US); Klaus H.W. Hartig, Avoca, WI (US); Keith J. Burrows, Mineral Point, WI (US); Harshad P. Patil, Madison, WI (US)

(21) Appl. No.: 12/915,871

(22) Filed: Oct. 29, 2010

(51) Int. Cl. B05D 5/12; B32B 7/02; B32B 15/04

(52) U.S. Cl. 428/141; 427/74; 428/432; 428/336; 428/213

(57) ABSTRACT

A glass substrate is provided having a major surface on which there is a coating comprising a transparent conductive oxide film. The TCO film may comprise aluminum-doped zinc aluminum oxide (“AZO”) or tin-doped indium oxide (“ITO”). When the coated glass substrate is heat-treated, the coating exhibits desirable sheet resistance and absorption values. In some cases, the coating comprises a first transparent dielectric film, a second transparent dielectric film, a transparent conductive oxide film comprising AZO or ITO, and a third transparent dielectric film.

### FIELD OF THE INVENTION

The present invention relates to thin film coatings for glass and other substrates. In particular, this invention relates to thin film coatings including transparent conductive oxide (“TCO”) films comprising aluminum-doped zinc oxide (“AZO”) or tin-doped indium oxide (“ITO”). Also provided are methods for producing such coatings. The invention also relates to photovoltaic devices incorporating substrates bearing such coatings.

### BACKGROUND OF THE INVENTION

Substrates bearing coatings that include TCO films are used in a number of applications. For example, these substrates can be used in photovoltaic solar cells, flat panel displays, electro-optical devices and other applications. These coatings are deposited to have desired electrical, optical and/or structural properties. However, in many applications, these coatings must undergo heat treatment in an oxygen-containing atmosphere, such as air. Unfortunately, after heat treatment, the desired properties of these coatings, particularly AZO coatings, either degrade, exhibiting less than desirable or acceptable electrical, optical and/or mechanical properties for a given application or do not improve to desired or acceptable ranges. For example, AZO film in TCO thin film coatings tend to lose a significant amount of electrical conductivity and/or exhibit increased sheet resistance and/or absorb oxygen when heated above about 400° C. At even higher temperatures, structural discontinuity of the AZO films can sometimes occur. As such, there is a need for improved TCO coatings, particularly coatings including AZO TCO film, that have good electrical, optical and/or mechanical properties after heat treatment and/or that do not degrade and/or that improve and/or that exhibit minimal oxygen absorption with heat treatment in an oxygen-containing atmosphere.

### SUMMARY OF THE INVENTION

Embodiments of the invention include transparent conductive coatings comprised of transparent conductive oxide films, coated substrates bearing such coating and photovoltaic devices that include coated substrates.

In an embodiment of the invention a coating comprising a transparent conductive oxide coating film is provided. The coating comprises in sequence a first transparent dielectric film, a second transparent dielectric film comprised of silicon dioxide, a transparent conductive oxide film, and a third dielectric film. The first transparent dielectric film may be formed of a material having an index of refraction greater than the second transparent dielectric film and/or greater than that of a substrate provided with the coating.

In another embodiment of the invention a coated substrate is provided. The coated substrate is a glass substrate having a major surface bearing thereover a coating comprising, in sequence outward from substrate: a first transparent dielectric film comprising a dielectric material having an index of refraction higher than the index of refraction of glass; a second transparent dielectric film comprising silicon dioxide; a transparent conductive oxide film; and a third transparent dielectric film.

In a further embodiment, a coated substrate is provided that is comprised of a glass substrate having a major surface bearing thereover a coating comprising, in sequence outward from substrate: a first transparent dielectric film comprising tin oxide; a second transparent dielectric film comprising silicon dioxide; a transparent conductive oxide film comprising aluminum-doped zinc oxide; and a third transparent dielectric film comprising tin oxide. In some embodiments, the third dielectric material may be instead comprised of titanium oxide.

The transparent conductive oxide film in some embodiments is aluminum-doped zinc oxide (AZO) or indium tin oxide (ITO). In other embodiments, when the transparent conductive oxide is AZO it comprises zinc oxide doped with between about 0.5% to about 4% aluminum.

In some embodiments, the first transparent dielectric film has a thickness of between about 100 Å and about 200 Å, the second transparent dielectric film has a thickness of between about 250 Å and about 350 Å, the transparent conductive oxide film has a thickness of between about 5000 Å and about 6000 Å, and the third transparent dielectric film has a thickness of between about 400 Å and about 1000 Å.

In an additional embodiment, the coating on the glass substrate is comprised of a single layer formed of a dielectric material, such as SiO2, having a thickness ranging from between about 400 Å and about 500 Å, a transparent conductive oxide film having a thickness of between about 5000 Å and about 6000 Å, and a third transparent dielectric film having a thickness of between about 400 Å and about 1000 Å.

In yet other embodiments, the third transparent dielectric film has a bi-layer structure comprising a first partially absorbing layer and a second, overlying non-absorbing layer. In embodiments having a bi-layer structure, the two layers of the bi-layer may be formed of the same or of different materials. In embodiments of the invention employing the bi-layer structure, the third transparent dielectric film may have an overall thickness of between about 500 Å and about 1500 Å.

In some embodiments of the invention in which the third transparent dielectric film has a bi-layer structure, the first partially absorbing layer has a thickness of between about 250 Å and about 1250 Å, the non-absorbing layer has a thickness of between about 250 Å and about 1250 Å, and the first partially absorbing layer and the non-absorbing layer have a combined thickness of between about 500 Å and about 1500 Å.

In a further embodiment of the invention, a heat treated coated glass substrate is provided having a major surface on which there is a coating comprising a transparent conductive oxide film comprised of aluminum-doped zinc oxide, wherein the coating has a sheet resistance of less than about 10 Ω/square and an absorption of about 6% or less.

In yet another aspect, a photovoltaic device is provided comprising a coated substrate bearing a transparent conductive coating according to any one of the embodiments of the invention, a semiconductor layer and a back electrode.

In another embodiment of the invention, a method of forming a coated glass substrate is provided. The method of this embodiment comprises the steps of: providing a glass substrate having a major surface; depositing a first transparent dielectric film over the major surface of the glass substrate; depositing a second transparent dielectric film over the first transparent dielectric film; depositing a transparent conductive oxide film over the second transparent dielectric film; and depositing a third transparent dielectric film over the transparent conductive film. In some embodiments, the step of depositing the third transparent dielectic film is comprised of depositing the third transparent dielectric film with a bi-layer construction. In such embodiments one layer of the bi-layer is a partially absorbing layer and the other layer is a non-absorbing layer. Methods of the invention may also include a heat treatment step.

### BRIEF DESCRIPTION OF THE DRAWINGS

FIG. 1 is a schematic cross-sectional view of a substrate having a major surface carrying a coating including a TCO film in accordance with certain embodiments;

FIG. 2 is a schematic cross-sectional view of a substrate having a major surface carrying another coating including a TCO film in accordance with certain embodiments;

FIG. 3 is a schematic cross-sectional view of a substrate having a major surface carrying another coating including a TCO film in accordance with certain embodiments;

FIG. 4 is a schematic cross-sectional view of a photovoltaic device in accordance with certain embodiments;

FIG. 5 is a graph showing solar transmission data before and after heat treatment for a substrate bearing a coating including an AZO TCO film in accordance with certain embodiments;

FIG. 6 is a graph showing bias testing data after heat treatment for a substrate bearing a coating including an AZO TCO film in accordance with certain embodiments;

FIG. 7 is an AFM image before heat treatment of substrate bearing a coating including an AZO TCO film in accordance with certain embodiments; and

FIG. 8 is an AFM image after heat treatment of substrate bearing a coating including an AZO TCO film in accordance with certain embodiments.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

The present invention involves a substrate bearing a TCO coating, particularly coatings that includes an AZO or an ITO TCO film, and is advantageous because it has one or more properties that remain stable and/or improve with heat treatment in an oxygen-containing atmosphere. As a result, the present coated substrate can be used in applications requiring heat treatment in an oxygen-containing atmosphere to provide a functional product and, in some embodiments, an improved product. For example, in certain applications, the coated substrate can be part of a photovoltaic device or included in residential windows with desirably low U-values or increased R-values, e.g., in insulating glass units.

As used herein, the term “heat treatment” refers to any process that results in heating of a substrate in an oxygen-containing atmosphere to a temperature above 400° C. and more specifically, a temperature between about 400° C. and about 700° C. For example, the heating can take place at a temperature of greater than 400° C., such as about 500° C., 550° C., 600° C., 690° C., or even 700° C. In some cases, the heating can take place at a temperature between about 500° C. and about 690° C. In addition to traditional heat treatment techniques, the term “heat treatment” may also refer to the application of short pulses of high intensity wavelengths from flash lamps. With such applications, the coating can be thermally processed without actual tempering of the glass. This can be useful when the glass substrate of coated glass substrates according to the invention does not need to be tempered prior to application of the coating for the intended end use. Flash lamps for processing of coatings are commercially available from vendors, such as Heraeus Noblelight, Duluth Ga.

Many embodiments of the invention involve a coated substrate. A wide variety of substrate types are suitable for use in the invention. In some embodiments, the substrate is a sheet-like substrate having generally opposed first and second major surfaces. For example, the substrate can be a sheet of transparent material (i.e., a transparent sheet). The substrate, however, is not required to be a sheet, nor is it required to be transparent.

For many applications, the substrate will comprise a transparent (or at least translucent) material, such as glass. For example, the substrate is a glass sheet in certain embodiments. A variety of known glass types can be used, such as soda-lime glass. In some cases, it may be desirable to use “white glass,” a low iron glass, etc.

Substrates of various sizes can be used in the present invention. Commonly, large-area substrates are used. Certain embodiments involve a substrate having a major dimension (e.g., a length or width) of at least about 0.5 meter, preferably at least about 1 meter, perhaps more preferably at least about 1.5 meters (e.g., between about 2 meters and about 4 meters), and in some cases at least about 3 meters. In some embodiments, the substrate is a jumbo glass sheet having a length and/or width that is between about 3 meters and about 10 meters (e.g., a glass sheet having a width of about 3.5 meters and a length of about 6.5 meters). Substrates having a length and/or width of greater than about 10 meters are also anticipated.

Substrates of various thicknesses can be used in the present invention. In some embodiments, the substrate (which can optionally be a glass sheet) has a thickness of about 1-5 mm. Certain embodiments involve a substrate with a thickness of between about 2.3 mm and about 4.8 mm, and perhaps more preferably between about 2.5 mm and about 4.8 mm. In one particular embodiment, a sheet of glass (e.g., soda-lime glass) with a thickness of about 3 mm is used.

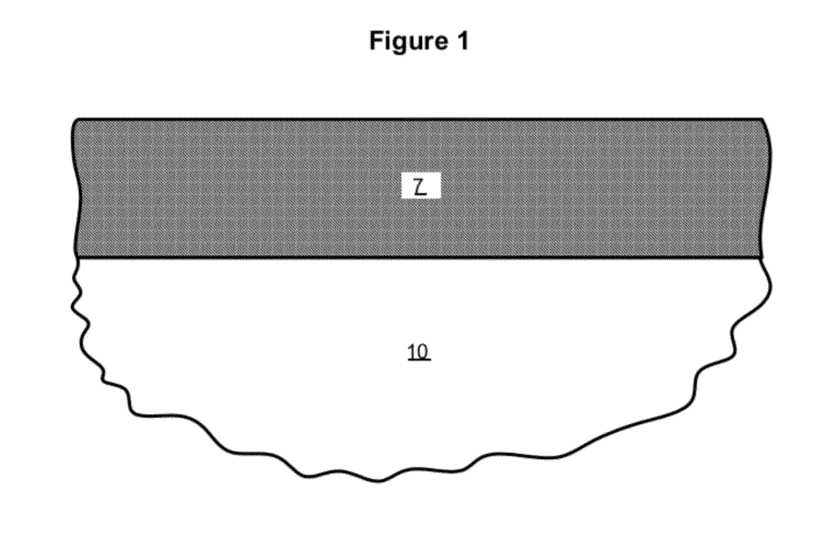

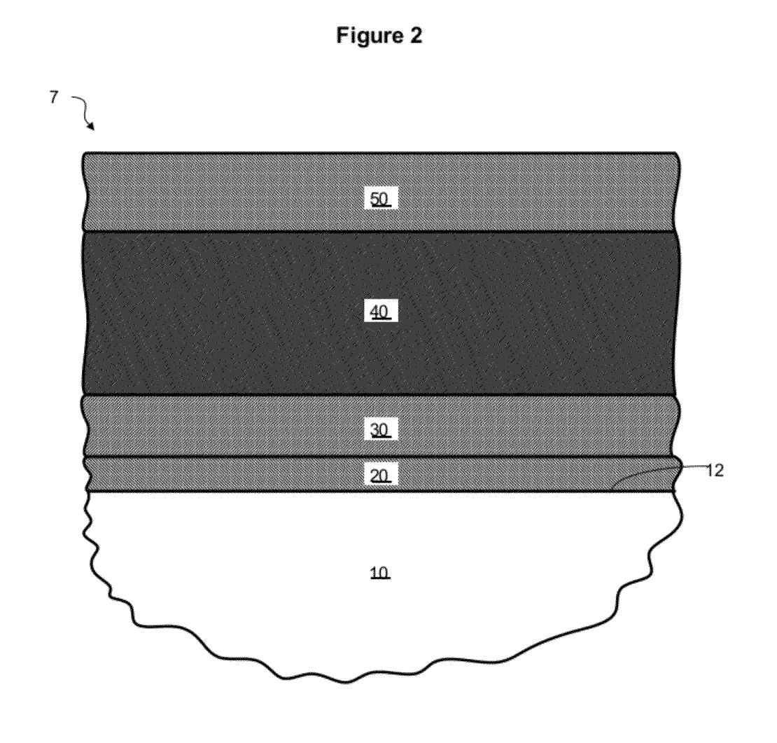

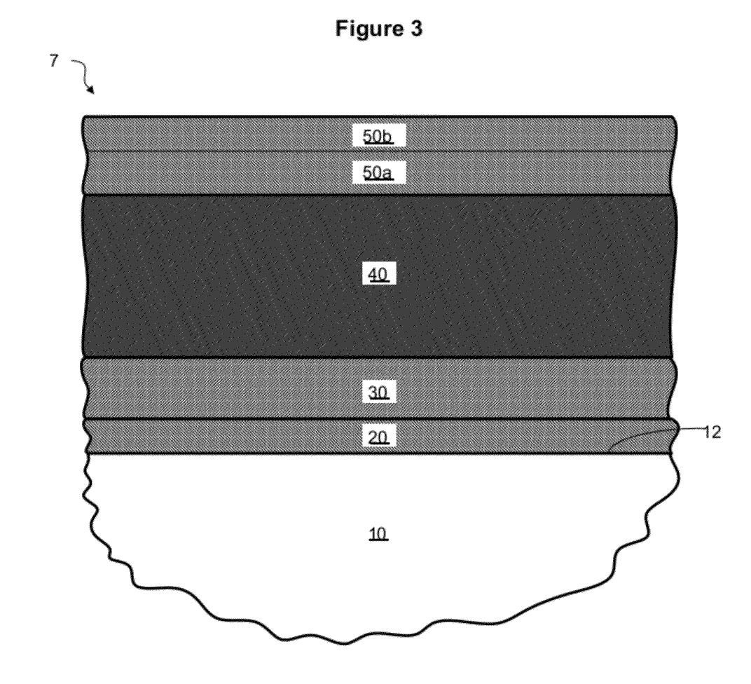

Preferably, the substrate 10 has opposed major surfaces. As shown in FIG. 1, the substrate 10 bears a coating 7. In FIG. 2, the coating 7 includes, in sequence from surface 12 outwardly, a first transparent dielectric film 20, a second transparent dielectric film 30, a transparent conductive oxide film 40 and a third transparent dielectric film 50 (also may be referred to as buffer layer 50). The films 20, 30, 40 and 50 can be in the form of discrete layers (i.e., non-graded or uniform layers). In some embodiments, one or more of films 20, 30, 40 and 50 may be formed of two or more discrete layers. In FIG. 3, the third transparent dielectric film 50 is a bi-layer including a first layer 50a and a second layer 50b. In certain cases, the first layer 50a is a partially absorbing layer wherein the second layer 50b is a non-absorbing layer.

The first transparent dielectric film 20 can have a thickness of between about 100 Å and about 200 Å, such as about 150 Å. The second transparent dielectric film 30 can have a thickness of between about 250 Å and about 350 Å, such as about 300 Å. In some cases, the first and second transparent dielectric films have a combined thickness of less than about 500 Å. The transparent conductive oxide 40 can have a thickness of between about 5000 Å and about 6000 Å, such as about 5500 Å, for AZO and a thickness of between about 2000 Å and about 3000 Å for ITO. Finally, the third transparent dielectric film 50 has a thickness of between about 400 Å and about 1000 Å, such as about 500 Å to about 1000 Å, or about 500 Å to about 750 Å, or about 700 Å to about 1000 Å, such as about 750 Å. In embodiments where the third transparent dielectric film 50 is a bi-layer (a first layer 50a and a second layer 50b), the total combined thickness of the two layers is between about 500 Å and about 1500 Å, such as about 500 Å, or about 1000 Å, or about 1500 Å. Each of layers 50a and 50b have a thickness of not less than about 250 Å. For example, the first layer 50a can have a thickness of between about 250 Å and about 1250 Å, such as about 250 Å, and the second layer 50b can have a thickness between about 250 Å and about 1250 Å, such as about 500 Å.

In some embodiments, the first transparent dielectric film 20 is formed of a first material and the second transparent dielectric film 30 is formed of a second material, wherein the first material has a higher refractive index than the second material. In certain cases, the first transparent dielectric film 20 comprises a dielectric material having a refractive index of 2.0 or of about 2.0, such as tin oxide, and the second transparent dielectric film 30 comprises a dielectric material having a refractive index of 1.5 or of about 1.5, such as silicon dioxide. This arrangement of the first and second transparent dielectric films helps to reduce glass side reflectance of the coating. In embodiments where the substrate is glass, the first dielectric material may also be selected so as to have refractive index higher than that of the glass substrate for antireflection purposes. Glass has a refractive index of about 1.5; and examples of dielectric materials having a refractive index greater than that of glass include, but are not limited to, tin oxide or titanium oxide to name a few.

In certain embodiments, a substrate is provided having a major surface on which there is a coating comprising, in sequence outward from substrate: a first transparent dielectric film 20 comprising, consisting essentially of, or consisting of tin oxide; a second transparent dielectric film 30 comprising, consisting essentially of, or consisting of silicon dioxide; a transparent conductive oxide film 40 comprising, consisting essentially of, or consisting of AZO or ITO; and a third transparent dielectric film 50 comprising, consisting essentially of, or consisting of tin oxide or of titanium oxide. Further, the transparent conductive oxide film 40 can include, for example, zinc oxide doped with between about 0.5% to about 4% aluminum or about 0.5% to about 2% aluminum, or indium oxide doped with about 10% tin oxide.

In certain other embodiments, the first layer 50a is a partially absorbing layer and the second layer 50b is a non-absorbing layer. In certain cases, the partially absorbing layer and non-absorbing layer comprise, consist essentially of, or consist of the same material. For example, in certain embodiments, the partially absorbing layer and non-absorbing layer both comprise, consist essentially of, or consist of tin oxide or of titanium oxide. The partially absorbing layer can be made partially absorbing by adjusting deposition parameters, e.g., the argon/oxygen ratio in the gas atmosphere during sputter deposition. In certain cases, the partially absorbing layer and non-absorbing layer comprise, consist essentially of, or consist of two different dielectric material, e.g. one of tin oxide and the other of titanium oxide.

When the coated substrate is part of a photovoltaic device, the third transparent dielectric film 50 of the coating acts as a buffer layer to avoid shunting of the photovoltaic device. The third transparent dielectric film 50 can improve the coating's resistance to moisture and acids and can also help to stabilize and/or improve the coating properties during heat treatment. Buffer layer 50 or the partially absorbing layer can serve to getter or absorb oxygen to prevent or minimize oxygen migration to transparent conductive film 40.

In further embodiments, a substrate is provided having a major surface on which there is a coating comprising, in sequence outward from substrate: a first transparent dielectric film 20 comprising, consisting essentially of, or consisting of tin oxide and having a thickness of between about 100 Å and about 200 Å; a second transparent dielectric film 30 comprising, consisting essentially of, or consisting of silicon dioxide and having a thickness of between about 250 Å and about 350 Å; a transparent conductive oxide film 40 comprising, consisting essentially of, or consisting of zinc oxide doped with aluminum and having a thickness of between about 5000 Å and about 6000 Å or consisting essentially of, or consisting of ITO and having a thickness of between about 2000 Å and about 3000 Å; and a third transparent dielectric film 50 comprising, consisting essentially of, or consisting of tin oxide and having a thickness of between about 400 Å and about 1000 Å. In certain embodiments, the third transparent dielectric film comprises a first partially absorbing layer 50a comprising, consisting essentially of, or consisting of absorbing tin oxide and a second non-absorbing layer 50b comprising, consisting essentially of, or consisting of tin oxide, wherein the first layer 50a has a thickness of between about 250 Å and about 1250 Å and the second layer has a thickness of between about 250 Å and about 1250 Å. In yet other embodiments, the layers 50a and 50b may both be formed of titanium oxide or the layers 50a, 50b may be formed of different dielectric materials. As previously mentioned, the first partially absorbing layer and the non-absorbing layer have a combined thickness of between about 500 Å and about 1500 Å.

In one particular embodiment, a substrate is provided having a major surface on which there is a coating comprising, in sequence outward from the substrate: a first transparent dielectric film 20 comprising tin oxide and having a thickness of about 150 Å; a second transparent dielectric film 30 comprising silicon dioxide and having a thickness of about 300 Å; a transparent conductive oxide film 40 comprising zinc oxide doped with aluminum and having a thickness of between about 5000 Å and about 6000 Å; and a third transparent dielectric buffer film 50 comprising tin oxide and having a thickness of between about 250 Å and about 1000 Å.

In certain embodiments, a coating is provided that is formed of materials, and made by a process, that allows the coated substrate to have properties that remain stable or improve with heat treatment in an oxygen-containing atmosphere. In particular embodiments, the coated substrate has one or more of the beneficial properties discussed below. The properties are reported herein for a single (i.e., monolithic) substrate bearing the present coating on one surface 12. Of course, these specifics are by no means limiting to the invention. Several optical properties can be measured using commercially available spectrophotometers, such as spectrophotometers available from Hunter Associates Laboratories, Inc. or PerkinElmer, Inc., Waltham, Mass. For example, the optical properties include absorption, solar transmission, reflectance, emissivity of the samples discussed herein below were measured using an Ultra-Scan Pro spectrophotomer, available from Hunter Associates Laboratories, Inc., Reston, Va., and can also be measured using FTIR spectrophotometers, such as those available from Perkin Elmer. Electrical properties such as resistivity, mobility and carrier concentrations can be measured using Hall Effect measuring devices such as the Variable Temperature Hall System (VTHS) available from MMR Technologies, Inc., Mountain View, Calif. Sheet resistance can be measured using a 4-point probe measurement or non-contact measurement.

Many of the properties discussed below have a value that is reported after heat treatment. Again, the term “heat treatment” as used herein refers to any process that results in heating of a substrate in an oxygen-containing atmosphere to a temperature between about 400° C. and about 700° C., such as perhaps between about 500° C. and about 690° C. and also refers to the application of short pulses of high intensity wavelengths from flash lamps, commercially available, for example from Heraeous Noblelight Ltd, Duluth, Ga.

The coating 7 exhibits acceptable sheet resistance after heat treatment. In some embodiments, the coating 7 also desirably may have a sheet resistance value that lowers after heat treatment. In some embodiments, the zinc aluminum oxide TCO film is electrically conductive and imparts low sheet resistance in the coating 7. In some embodiments, the coating 7 has a first sheet resistance value before heat treatment and a second sheet resistance value after heat treatment, wherein the sheet resistance is lower after heat treatment. In certain cases, the coating has a sheet resistance of less than about 10 Ω/square after heat treatment (e.g., less than 9 Ω/square, less than 8 Ω/square, or even less than 7 Ω/square). The sheet resistance of the coating can be measured using a 4-point probe or non-contact measurement. Other methods known in the art as being useful for calculating sheet resistance can also be used.

The coating 7 also has low absorption after heat treatment. In some embodiments, the coating 7 also has an absorption value that lowers after heat treatment. In certain cases, the coating has an absorption of less than about 7%, less than about 6%, less than about 5% or even less than about 4% after heat treatment. In some embodiments, the heat treated coating 7 has an absorption value of about 5.5% to about 6%. Some coatings according to the invention can exhibit absorption values greater than about 10% prior to heat treatment. For example, some coatings made according to the invention have even exhibited absorption values greater than about 13%, e.g., about 13% to about 19%, prior to heat treatment, and, after heat treatment, have exhibited absorption values of less than 10%, e.g., about 7% to about 4%.

In some embodiments, the coating 7 also has a low surface roughness value after heat treatment. Also, the coating 7 may have a surface roughness value that remains stable or even lowers after heat treatment in some embodiments. For example, the coating has an average surface roughness value of less than about 10 nm after heat treatment. For example, the coating preferably has a surface roughness of less than 8 nm, less than 7 nm, less than 6 nm, or even less than 5 nm. The deposition method and conditions preferably are chosen so as to provide the coating with such a roughness.

In some embodiments, the coating 7 has desirably low emissivity after heat treatment. In some embodiments, the coating 7 also has an emissivity value that remains stable at an acceptable level or that even lowers after heat treatment. In certain cases, the coating 7 has an emissivity of about 0.3 or less after heat treatment, such as about 0.1 to about 0.3. Preferably, the emissivity of this coating 7 is less than about 0.25, less than about 0.22, less than about 0.2, or even less than about 0.18, such as about 0.15 after heat treatment. In contrast, an uncoated pane of clear glass would typically have an emissivity of about 0.84.

The term “emissivity” is well known in the present art. This term is used herein in accordance with its well-known meaning to refer to the ratio of radiation emitted by a surface to the radiation emitted by a blackbody at the same temperature. Emissivity is a characteristic of both absorption and reflectance. It is usually represented by the formula: E=1−Reflectance. Emissivity values can be determined as specified in “Standard Test Method For Emittance Of Specular Surfaces Using Spectrometric Measurements” NFRC 301-93, the entire teachings of which are incorporated herein by reference.

In some embodiments, the coating 7 may also have low resistivity after heat treatment. In some other embodiments, the coating 7 has a resistivity value that lowers after heat treatment and has a first resistivity value before heat treatment and a second resistivity value after heat treatment. In certain cases, the coating 7 has a resistivity of less than about 8×10⁻⁴ Ω/cm after heat treatment, such as about 5.88 E-04 Ω/cm. The resistivity can be measured by obtaining standard Hall Effect measurements and then calculating resistivity.

The coating desirably may also have a high solar transmittance after heat treatment. In some embodiments, the coating 7 has a solar transmittance value that increases after heat treatment. In some cases, the coating 7 has a solar transmittance of greater than about 75%, or greater than about 80% after heat treatment.

In some embodiments, the coating 7 also has low visible reflectance after heat treatment. In some cases, the coating 7 has a reflectance value that remains stable or even lowers after heat treatment. The reflectance value is the visible reflectance off either the glass side or the film side of the coated substrate. The coated substrate can have a visible reflectance (off either the glass side or the film side) of less than about 20%, less than about 18%, less than about 15%, or even less than about 10%.

In some embodiments, the coating also has a high carrier concentration after heat treatment. For example, in some cases, the coating has a carrier concentration of about 5.90 E+20/cm3 after heat treatment. The carrier concentration can be measured by obtaining standard hall effect measurements and calculating carrier concentration.

In some embodiments, the coating has a mobility value greater than 17. In some other embodiments the coating has a mobility value of about or greater than 18. The mobility value of some coating according to the invention can be between about 18 to about 23 after heat treatment. Mobility values can be obtained via standard hall effect measurements

In an embodiment, a substrate bearing a coating according to the invention has a sheet resistance of less than 10 Ω/square and absorption of less than 10% such as an absorption of about 5.5-6%.

In certain embodiments, a glass substrate is provided having a major surface on which there is a coating comprising an AZO TCO film, wherein the coating is subjected to heat treatment in an oxygen-containing atmosphere, wherein after heat treatment the coating has one or more of the following properties: an emissivity of less than about 0.3, an average surface roughness of less than about 8 nm, a film side reflectance of less than about 17, a sheet resistance of less than about 10 Ω/square, and/or a solar transmittance of at least about 75%.

Table 1 below shows four exemplary film stacks that can be used as the coating 7:

TABLE 1

| | SAMPLE | SAMPLE | SAMPLE | SAMPLE |
|---|---|---|---|---|
| FILM | A | B | C | D |
| SnO₂ | 150 Å | 150 Å | 150 Å | 150 Å |
| SiO₂ | 300 Å | 300 Å | 300 Å | 300 Å |
| AZO | 6000 Å | 5500 Å | 6000 Å | 6000 Å |
| SnO₂ | 250 Å | 500 Å | 350 Å | 500 Å |

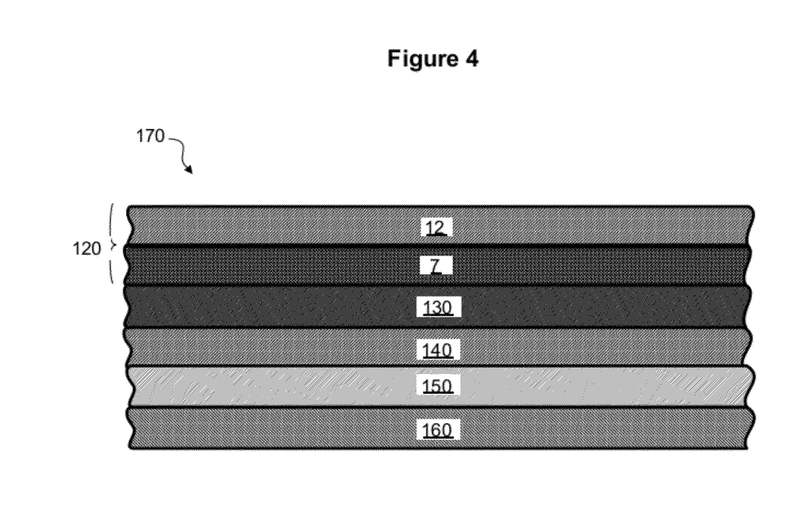

In certain applications, the coated substrate is part of a photovoltaic device. Photovoltaic devices such as solar cells convert solar radiating and other light into usable energy. Certain embodiments are applicable to photovoltaic devices that typically undergo high processing temperatures in oxygen-containing atmospheres to make the devices. For example, the device might undergo processing in temperatures of between about 400° C. to about 700° C. FIG. 4 illustrates an exemplary photovoltaic device 170. The photovoltaic device includes a front electrode 120, a semiconductor film 130 and a back electrode 140. The device can also include an optional adhesive layer 150 and an optional glass substrate 160.

In certain cases, the front electrode 120 includes a substrate bearing a coating 7 in accordance with any of the embodiments described above. Further, the semiconductor film 130 can include any semiconductor material known in the art. Likewise, the semiconductor film 130 can include one film or a plurality of films depending on the desired application and may be formed of any semiconductor material known to be suitable to those skilled in the art. In certain embodiments, the semiconductor film 130 includes a semiconductor material that is deposited onto the front electrode 120 using high temperature processing, for example at temperatures above about 400° C. For example, the semiconductor film 130 can comprise, consist essentially of, or consist of a film of material selected from the group consisting of CdTe, CIS, CIGS, microcrystalline Si and amorphous Si. Finally, the back electrode 140 can include any standard material used in the art for back electrodes.

The invention also provides several methods for producing the coating 7. Any of various know deposition techniques may be employed to deposit or apply one or more of the layers of coating 7, e.g. the TCO layer. Such deposition techniques include, but are not limited to, sputtering, chemical vapor deposition (CVD), plasma vapor deposition (PVD), plasma-enhanced chemical vapor deposition (PECVD), metalorganic chemical vapor deposition (MOCVD), hybrid physical-chemical vapor deposition (HPCVD), spray method, and pyrolytic deposition to name a view. In preferred embodiments, the films are deposited by sputtering. It is contemplated that deposition techniques that may be developed in the future may be utilized to deposit coatings according to the invention.

Sputtering is well known in the present art. In accordance with the present methods, a substrate 10 having a surface 12 is provided. If desired, this surface 12 can be prepared by suitable washing or chemical preparation. The coating 7 is deposited on the surface 12 of the substrate 10, e.g., as a series of discrete layers. The coating can be deposited using any thin film deposition technique that is suitable for depositing the desired film materials at the desired thicknesses. Thus, the present invention includes method embodiments wherein, using any one or more appropriate thin film deposition techniques, the film regions of any embodiment disclosed herein are deposited sequentially upon a substrate (e.g., a sheet of glass or plastic). One preferred method utilizes DC magnetron sputtering, which is commonly used in the industry. Reference is made to Chapin's U.S. Pat. No. 4,166,018, the teachings of which are incorporated herein by reference. In preferred embodiments, the present coatings are sputtered by AC or pulsed DC from a pair of cathodes. High power impulse magnetron sputtering (“HiPIMS”) and other modern sputtering methods can be used as well.

Briefly, magnetron sputtering involves transporting a substrate through a series of low pressure zones (or “chambers” or “bays”) in which the various film regions that make up the coating are sequentially applied. To deposit oxide film, the target may be formed of an oxide itself (e.g., aluminum-doped zinc oxide), and the sputtering may proceed in an inert or oxidizing atmosphere. Alternatively, the oxide film can be applied by sputtering one or more metallic targets (e.g., of metallic zinc doped with aluminum sputtering material) in a reactive atmosphere, e.g., an oxygen-containing atmosphere. To deposit AZO film, for example, a ceramic AZO target can be sputtered in an inert or oxidizing atmosphere. The thickness of the deposited film can be controlled by varying the speed of the substrate by varying the power on the targets, or by varying the ratio of power to partial pressure of the reactive gas.

In an embodiment of the invention, a method of forming a coated glass substrate is provided. The method of this embodiment comprises the steps of: providing a glass substrate having a major surface; depositing a first transparent dielectric film over the major surface of the glass substrate; depositing a second transparent dielectric film over the first transparent dielectric film; depositing a transparent conductive oxide film over the second transparent dielectric film; and depositing a third transparent dielectric film over the transparent conductive film. In some embodiments, the step of depositing the third transparent dielectic film is comprised of depositing the third transparent dielectric film with a bi-layer construction. In such embodiments one layer of the bi-layer is a partially absorbing layer and the other layer is a non-absorbing layer. Methods of the invention may also include a heat treatment step.

It should be understood that the coatings described herein above including the types of materials, thickness ranges and properties are applicable to the methods of the invention and to the coatings formed by the methods of the invention.

### EXAMPLES

Following are a few exemplary methods for depositing the coating 7 onto a glass substrate.

An exemplary method of depositing Sample A will now be described. A pair of rotatable tin targets were sputtered as an uncoated glass substrate was conveyed past the activated targets at a rate of about 223 inches per minute. A power of 25 kW was used, and the sputtering atmosphere was 6 mTorr with a gas flow of 1285 sccm/min argon and 398 sccm/min oxygen. The resulting tin oxide film had a thickness of about 150 Å. Directly over this tin oxide film a silicon dioxide film was applied. Here, the silicon dioxide was applied at a thickness of about 300 Å by conveying the glass sheet at about 150 inches per minute past a pair of rotary silicon aluminum targets (83% Si, 17% Al, by weight) sputtered at a power of 37.5 kW in a 5 mTorr atmosphere with a gas flow of 1462 sccm/min argon and 190-202 sccm/min oxygen. Directly over this silicon dioxide film a AZO film was applied. Here, the AZO film was applied at a thickness of about 6000 Å by conveying the glass sheet at about 11.5 inches per minute past a pair of rotatable zinc aluminum oxide targets (98% Zn, 2% Al, by weight) sputtered at a power of 30 kW in a 7.2 mTorr atmosphere with a gas flow of 3025 sccm/min argon and 0 sccm/min oxygen. Directly over this AZO film a tin oxide film was applied. Here, the tin oxide film was applied at a thickness of about 250 Å by conveying the glass sheet at about 186.8 inches per minute past a pair of rotatable tin targets sputtered at a power of 25 kW in a 6 mTorr atmosphere with a gas flow of 1300 sccm/min argon and 377 sccm/min oxygen. The coated substrate was then heat treated by annealing in air for 7.2 minutes at a maximum temperature of about 575° C. The properties of Sample A measured before and after heat treatment are shown below in Table 2.

TABLE 2
(Properties of Sample A)

| AS DEPOSITED | | | | HEAT TREATED | | | |
|---|---|---|---|---|---|---|---|
| T | R_{f} | Abs | SR | T | R_{f} | Abs | SR |
| 65.2 | 14.9 | 19.9 | 18.8 | 81.0 | 13.0 | 6.0 | 6.8 |

As shown in Table 2, Sample A had a solar transmission (T) of 65.2% before heat treatment and of 81.0% after heat treatment, resulting in an approximate 24% increase in solar transmission after heat treatment. Sample A also had a visible reflectance (R_{f}) of 14.9% before heat treatment and of 13.0% after heat treatment, resulting in an approximate 13% decrease in visible reflectance after heat treatment. Sample A also had an absorption (Abs) of 19.9% before heat treatment and 6.0% after heat treatment, resulting in an approximate 70% decrease in absorption after heat treatment. Finally, Sample A had a sheet resistance (SR) of 18.8 Ω/square before heat treatment and of 6.8 Ω/square after heat treatment, resulting in an approximate 63% decrease in sheet resistance after heat treatment.

An exemplary method of depositing Sample B will now be described. A pair of rotatable tin targets were sputtered as an uncoated glass substrate was conveyed past the activated targets at a rate of about 30.7 inches per minute. A power of 10 kW was used, and the sputtering atmosphere was 4.5 mTorr with a gas flow of 0 sccm/min argon and 808 sccm/min oxygen. The resulting tin oxide film had a thickness of about 150 Å. Directly over this tin oxide film a silicon dioxide film was applied. Here, the silicon dioxide was applied at a thickness of about 300 Å by conveying the glass sheet at about 30.7 inches per minute past a pair of rotary silicon aluminum targets (83% Si, 17% Al, by weight) sputtered at a power of 53 kW in a 4.5 mTorr atmosphere with a gas flow of 912 sccm/min argon and 808 sccm/min oxygen. Directly over this silicon dioxide film a zinc aluminum oxide film was applied. Here, the zinc aluminum oxide film was applied at a thickness of about 5500 Å by conveying the glass sheet at about 20.1 inches per minute past a pair of rotatable zinc aluminum oxide targets (98% Zn, 2% Al, by weight) sputtered at a power of 30 kW in a 6.8 mTorr atmosphere with a gas flow of 4056 sccm/min argon and 0 sccm/min oxygen. Directly over this zinc aluminum oxide film a tin oxide film was applied. Here, the tin oxide film was applied at a thickness of about 500 Å by conveying the glass sheet at about 92.1 inches per minute past a pair of rotatable tin targets sputtered at a power of 25 kW in a 6 mTorr atmosphere with a gas flow of 1811 sccm/min argon and 401 sccm/min oxygen. The coated substrate was then heat treated by annealing in air for 7.2 minutes at a maximum temperature of about 690° C. The properties of Sample B measured before and after heat treatment are shown below in Table 3.

TABLE 3
(Properties of Sample B)

| AS DEPOSITED | | | | HEAT TREATED | | | |
|---|---|---|---|---|---|---|---|
| T | R_{f} | Abs | SR | T | R_{f} | Abs | SR |
| 66.1 | 18.3 | 15.6 | 20.5 | 80.6 | 14.5 | 5.0 | 9.9 |

As shown in Table 3, Sample B had a solar transmission 66.1% before heat treatment and of 80.6% after heat treatment, resulting in an approximate 22% increase in solar transmission after heat treatment. Sample B also had a visible reflectance of 18.3% before heat treatment and of 14.5% after heat treatment, resulting in an approximate 21% decrease in visible reflectance after heat treatment. Sample B also had an absorption of 15.6% before heat treatment and of 5.0% after heat treatment, resulting in an approximate 68% decrease in absorption after heat treatment. Finally, Sample B had a sheet resistance of 20.5 Ω/square before heat treatment and of 9.9 Ω/square after heat treatment, resulting in an approximate 52% decrease in sheet resistance after heat treatment.

An exemplary method of depositing Sample C will now be described. A pair of rotatable tin targets were sputtered as an uncoated glass substrate was conveyed past the activated targets at a rate of about 208.8 inches per minute. A power of 25 kW was used, and the sputtering atmosphere was 6 mTorr with a gas flow of 1254 sccm/min argon and 419 sccm/min oxygen. The resulting tin oxide film had a thickness of about 150 Å. Directly over this tin oxide film a silicon dioxide film was applied. Here, the silicon dioxide was applied at a thickness of about 300 Å by conveying the glass sheet at about 165.8 inches per minute past a pair of rotary silicon aluminum targets (83% Si, 17% Al, by weight) sputtered at a power of 37.5 kW in a 5 mTorr atmosphere with a gas flow of 1172 sccm/min argon and 180-187 sccm/min oxygen. Directly over this silicon dioxide film a zinc aluminum oxide film was applied. Here, the zinc aluminum oxide film was applied at a thickness of about 6000 Å by conveying the glass sheet at about 12.25 inches per minute past a pair of rotatable zinc aluminum oxide targets (98% Zn, 2% Al, by weight) sputtered at a power of 30 kW in a 7.2 mTorr atmosphere with a gas flow of 3034 sccm/min argon and 0 sccm/min oxygen. Directly over this zinc aluminum oxide film a tin oxide film was applied. Here, the tin oxide film was applied at a thickness of about 350 Å by conveying the glass sheet at about 123.6 inches per minute past a pair of rotatable tin targets sputtered at a power of 25 kW in a 6 mTorr atmosphere with a gas flow of 1280 sccm/min argon and 396 sccm/min oxygen. The coated substrate was then heat treated by annealing in air for 7.2 minutes at a maximum temperature of about 690° C. The properties of Sample C measured before and after heat treatment are shown below in Table 4.

TABLE 4
(Properties of Sample C)

| AS DEPOSITED | | | | HEAT TREATED | | | |
|---|---|---|---|---|---|---|---|
| T | R_{f} | Abs | SR | T | R_{f} | Abs | SR |
| 64.4 | 16.4 | 19.2 | 18.8 | 82.0 | 13.4 | 4.6 | 11.1 |

As shown in Table 4, Sample C had a solar transmission of 64.4% before heat treatment and of 82.0% after heat treatment, resulting in an approximate 27% increase in solar transmission after heat treatment. Sample C also had a visible reflectance of 16.4% before heat treatment and of 13.4% after heat treatment, resulting in an approximate 18% decrease in visible reflectance after heat treatment. Sample C also had an absorption of 19.2% before heat treatment and of 4.6% after heat treatment, resulting in an approximate 76% decrease in absorption after heat treatment. Finally, Sample C had a sheet resistance of 18.8 Ω/square before heat treatment and of 11.1 Ω/square after heat treatment, resulting in an approximate 41% decrease in sheet resistance after heat treatment.

An exemplary method of depositing Sample D will now be described. A pair of rotatable tin targets were sputtered as an uncoated glass substrate was conveyed past the activated targets at a rate of about 208.8 inches per minute. A power of 25 kW was used, and the sputtering atmosphere was 6 mTorr with a gas flow of 1254 sccm/min argon and 416 sccm/min oxygen. The resulting tin oxide film had a thickness of about 150 Å. Directly over this tin oxide film a silicon dioxide film was applied. Here, the silicon dioxide was applied at a thickness of about 300 Å by conveying the glass sheet at about 165.8 inches per minute past a pair of rotary silicon aluminum targets (83% Si, 17% Al, by weight) sputtered at a power of 37.5 kW in a 5 mTorr atmosphere with a gas flow of 1186 sccm/min argon and 490 sccm/min oxygen. Directly over this silicon dioxide film a zinc aluminum oxide film was applied. Here, the zinc aluminum oxide film was applied at a thickness of about 6000 Å by conveying the glass sheet at about 12.3 inches per minute past a pair of rotatable zinc aluminum oxide targets (98% Zn, 2% Al, by weight) sputtered at a power of 30 kW in a 7.2 mTorr atmosphere with a gas flow of 3045 sccm/min argon and 0 sccm/min oxygen. Directly over this zinc aluminum oxide film a tin oxide film was applied. Here, the tin oxide film was applied at a thickness of about 500 Å by conveying the glass sheet at about 62.7 inches per minute past a pair of rotatable tin targets sputtered at a power of 25 kW in a 6 mTorr atmosphere with a gas flow of 1254 sccm/min argon and 416 sccm/min oxygen. The coated substrate was then heat treated by annealing in air for ten minutes at a temperature of about 500° C. Sample D was subjected to a series of tests. The results of each of these tests will now be discussed in more detail.

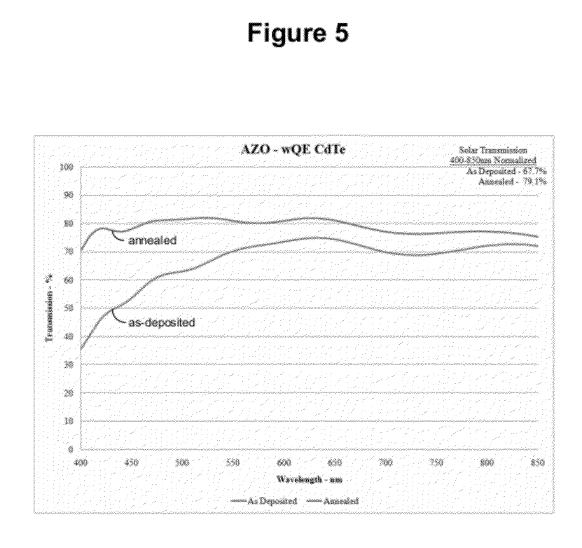

FIG. 5 is a graph showing solar transmission data for Sample D before and after heat treatment. As shown, FIG. 5 illustrates that before heat treatment, Sample D has a solar transmission of 67% wherein after heat treatment, Sample D has a solar transmission of 79.1%. Thus, heat treatment caused Sample D's solar transmission to increase by about 18%.

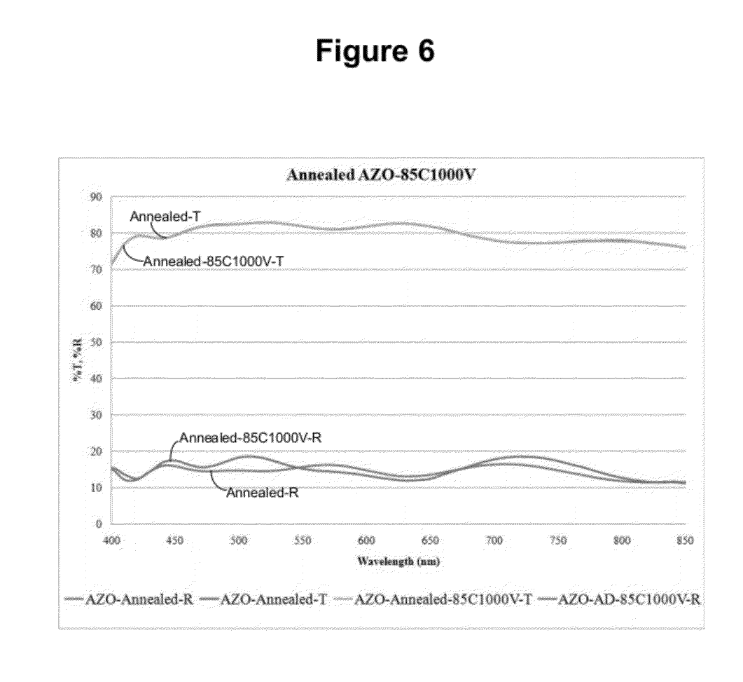

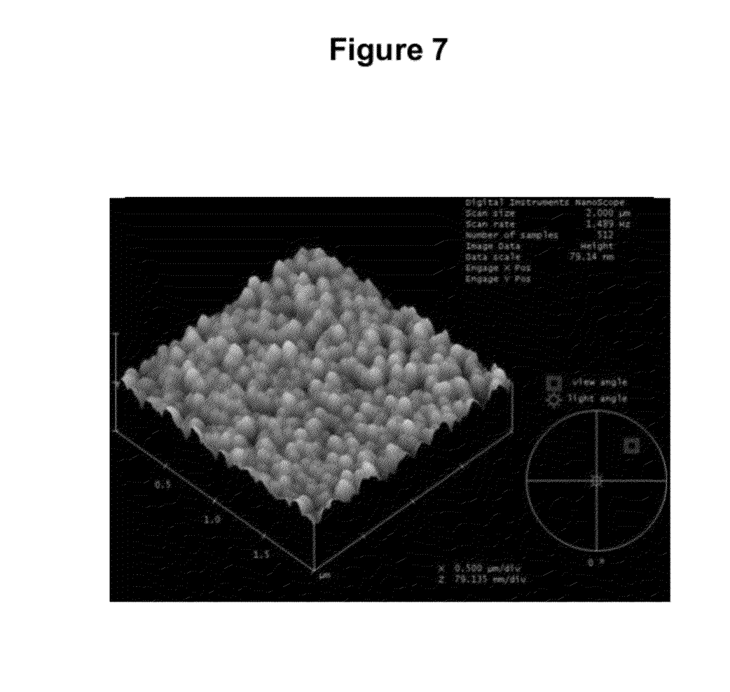

FIG. 6 shows bias testing data after heat treatment for Sample D. Again, the solar transmission and visible reflectance curves across the 400-850 nm spectrum was first measured. Next, a voltage of 1000 v was applied at 85° C. to Sample D. Next, the solar transmission and visible reflectance curves were again measured. FIG. 7 shows that both curves remained substantially similar or the same after the application of 1000 v at 85° C. This also shows that heat treatment at 500° C. did not affect Sample D's ability to withstand the application of 1000 v at 85° C.

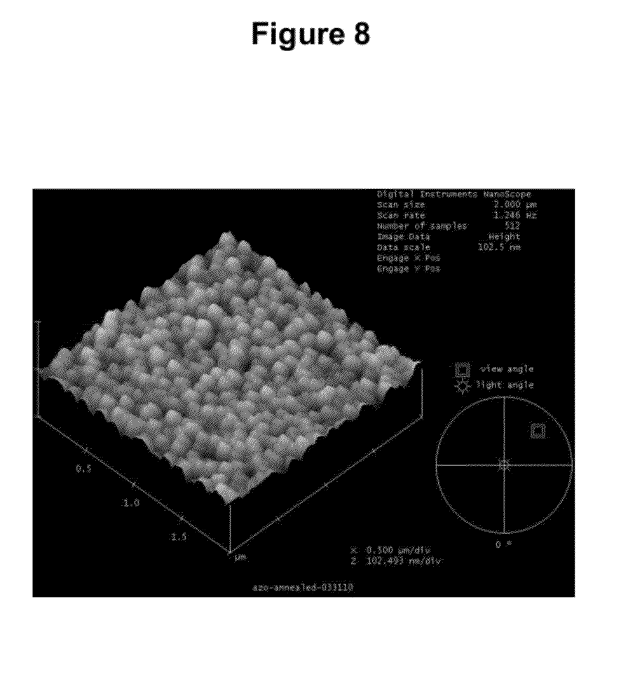

FIG. 7 is an atomic force microscope image (“ATM image”) of Sample D before heat treatment. Likewise, FIG. 8 is an ATM image of Sample D after heat treatment. Both ATM images show that Sample D has a relatively smooth surface and has a low surface roughness before and after heat treatment.

Further, the surface roughness properties of Sample D measured before and after heat treatment are shown below in Table 5.

TABLE 5
(Surface Roughness Properties of Sample D)

| AS DEPOSITED | | HEAT TREATED | |
|---|---|---|---|
| Average Roughness Ra (nm) | 5.3 | Average Roughness Ra (nm) | 5.1 |
| Root Mean Square Roughness | 6.6 | Root Mean Square Roughness | 6.4 |
| Rq (nm) | | Rq (nm) | |

Table 5 shows that the surface roughness properties of Sample D remain stable after heat treatment. Finally, the electrical properties of Sample D were measured after heat treatment are shown below in Table 6.

TABLE 6
(Electrical Properties of Sample D)
HEAT TREATED

| | |
|---|---|
| Carrier Concentration | 5.90E+20 cm³ |
| Resistivity | 5.88E−04 Ω · cm |
| Sheet Resistance | 8.9 Ω/square |
| Mobility | 18.1 cm²/(V s) |

Table 6 illustrates that after heat treatment, Sample D had a high carrier concentration and a high mobility. Coatings having a high carrier concentration and mobility indicate a coating having low defects in the film and a tightly interconnected grain structure. Table 6 also illustrates that Sample D had a low resistivity and a low sheet resistance, which are also desirable because they indicate a coating having excellent electrical conductivity.]

Finally, the emissivity of Sample D was measured before and after heat treatment and is shown below in Table 7.

TABLE 7
(Emissivity of Sample D)

| AS DEPOSITED | HEAT TREATED |
|---|---|
| .27 | .23 |

Table 7 illustrates that Sample D had an emissivity of 0.27 before heat treatment and 0.23 after heat treatment, resulting in an approximate 15% decrease in emissivity after heat treatment.

While some preferred embodiments of the invention have been described, it should be understood that various changes, adaptations and modifications may be made therein without departing from the spirit of the invention and the scope of the appended claims.

What is claimed is:

1. A glass substrate having a major surface bearing thereover a coating comprising, in sequence outward from the substrate:
a first transparent dielectric film comprising a dielectric material having an index of refraction higher than the index of refraction of glass;
a second transparent dielectric film comprising silicon dioxide;
a transparent conductive oxide film comprising aluminum-doped zinc oxide; and
a third transparent dielectric film comprising tin oxide.

2. The glass substrate of claim 1 wherein the first transparent dielectric comprises tin oxide.

3. The glass substrate of claim 1 wherein the transparent conductive oxide film comprises zinc oxide doped with between about 0.5% to about 4% aluminum.

4. The glass substrate of claim 1 wherein the transparent conductive oxide film has a thickness of between about 5000 Å and about 6000 Å.

5. The glass substrate of claim 1 wherein the first transparent dielectric film has a thickness of between about 100 Å and about 200 Å.

6. The glass substrate of claim 1 wherein the second transparent dielectric film has a thickness of between about 250 Å and about 350 Å.

7. The glass substrate of claim 1 wherein the third transparent dielectric film has a thickness of between about 400 Å and about 1000 Å.

8. The glass substrate of claim 1 wherein the third transparent dielectric film has a bi-layer structure comprising a first partially absorbing layer and a second, overlying non-absorbing layer.

9. The glass substrate of claim 8 wherein the first partially absorbing layer has a thickness of between about 250 Å and about 1250 Å, the non-absorbing layer has a thickness of between about 250 Å and about 1250 Å, and the first partially absorbing layer and the non-absorbing layer have a combined thickness of between about 500 Å and about 1500 Å.

10. The glass substrate of claim 1 wherein the coating has a sheet resistance of less than about 10 Ω/square after heat treatment.

11. The glass substrate of claim 1 wherein the coating has a resistivity of less than about 8×10⁻⁴ Ω/cm after heat treatment.

12. The glass substrate of claim 1 wherein the coating has an absorption of less than about 6% after heat treatment.

13. The glass substrate of claim 1 wherein the coating has an average surface roughness value of less than about 8 nm after heat treatment.

14. A heat treated glass substrate having a major surface on which there is a coating comprising a transparent conductive oxide film comprised of aluminum-doped zinc oxide, wherein the coating has a sheet resistance of less than about 10 Ω/square and an absorption of 7% or less.

15. The glass substrate of claim 14 wherein the transparent conductive oxide film is doped with between about 0.5% to about 4% aluminum.

16. The glass substrate of claim 14 wherein the transparent conductive oxide has a thickness of between about 5000 Å to about 6000 Å.

17. The glass substrate of claim 14 wherein the coating comprises, in sequence outward from substrate:
a first transparent dielectric film comprising tin oxide;
a second transparent dielectric film comprising silicon dioxide;
a transparent conductive oxide film comprising zinc aluminum oxide; and
a third transparent dielectric film comprising tin oxide or titanium oxide.

18. The glass substrate of claim 14 wherein the coating comprises, in sequence outward from substrate:
a first transparent dielectric film having a thickness of between about 100 Å and about 200 Å;
a second transparent dielectric film having a thickness of between about 250 Å and about 350 Å and a index of refraction lower than that of the first transparent dielectric layer;
the transparent conductive oxide film having a thickness of between about 5000 Å to about 6000 Å; and
a third transparent dielectric film having a thickness of between about 400 Å and about 1000 Å.

19. A method of forming a coated glass substrate having a major surface, comprising:
providing a glass substrate having a major surface;
depositing a first transparent dielectric film over the major surface of the glass substrate;
depositing a second transparent dielectric film over the first transparent dielectric film;
depositing a transparent conductive oxide film over the second transparent dielectric film; and
depositing a third transparent dielectric film over the transparent conductive film.

20. The method of claim 19 wherein the first transparent dielectric film has a refractive index greater than the refractive index of glass.

21. The method of claim 19 wherein the first transparent dielectric film comprises tin oxide; the second transparent dielectric film comprises silicon dioxide; the transparent conductive oxide film comprises aluminum-doped zinc oxide; and the third transparent dielectric film comprises tin oxide.

22. The method of claim 19 wherein the step of depositing the third transparent dielectic film is comprised of depositing the third transparent dielectric film with a bi-layer construction, including a partially absorbing layer and a non-absorbing layer.

23. The method of claim 19 further comprising the step of heat treating the coated glass substrate.
